(19) United States
(12) Patent Application Publication
(10) Pub. No.: US 2026/0299583 A1
(43) Pub. Date: Oct. 1, 2026

(54) SYSTEMS, ACTUATOR APPARATUSES, AND METHODS FOR AUTOMATED MACHINE CONTROL

(71) Applicant: Dianomix Inc., Calgary (CA)

(72) Inventor: Marius Ulsamer, Calgary (CA)

(73) Assignee: Dianomix Inc., Calgary (CA)

(21) Appl. No.: 19/630,229

(22) Filed: Mar. 26, 2026

Related U.S. Application Data
(60) Provisional application No. 63/778,968, filed on Mar. 27, 2025.

(51) Int. Cl. G05D 1/227; A01D 34/00; A01D 101/00; F16C 1/12; G05D 107/20

(52) U.S. Cl. CPC G05D 1/227; A01D 34/008; F16C 1/12; A01D 2101/00; G05D 2107/24

(57) ABSTRACT

A system for retrofitting a machine to enable an enabling automated or remote control mode of operation of a machine is provided. The system includes one or more actuator apparatuses connectable to one or more machine control components of the machine. The system includes a control system operatively connected to the one or more actuator apparatuses, the control system generating control signalling to operate the one or more actuator devices during the automated or remote control mode of operation. At least one actuator apparatus comprises a cable actuator apparatus comprising a cable. The control system is operable to stop the automated or remote control mode of operation, comprising causing the cable actuator apparatus to extend the cable. The system may include a rotary actuator apparatus. A controller is also provided.

### RELATED APPLICATION

The present disclosure claims priority to U.S. Provisional Patent Application No. 63/778,968, filed on Mar. 27, 2025, the entire contents of which are incorporated herein by reference.

### FIELD OF THE DISCLOSURE

The present disclosure relates to systems for controlling a machine such as a vehicle or commercial equipment. More particularly, the present disclosure relates to systems including actuators for retrofitting automated control of the machine.

### BACKGROUND

Automated vehicles such as self-driving cars, automated commercial equipment, and more, may navigate roads and pathways without human intervention. Machines in various industries may potentially be automated. However, replacing existing equipment with automated equipment may be costly. Additionally, particular industries may present unique challenges. These machines have typically been refined over decades to meet the unique demands of the job, making them well-suited to their tasks in their current human-operated form and ideal candidates for retrofit-based automation rather than full replacement.

Golf turf maintenance equipment such as mowers, golf ball pickers, and more may be highly specialized. In addition to the cost of replacing the equipment, automating golf turf maintenance equipment may face other challenges. Maintaining the turf of a golf course detailed awareness of the course environment, the turf itself, and a high degree of precision and care. As a result, machines used to maintain the turf must be controlled with a high degree of precision. Additionally, extra care must be taken to avoid inadvertent damage to the turf. Golf course and their clientele place a high value on the appearance and quality of the turf. Turf maintenance tasks are often repetitive, performed daily, and demand precise execution, such as centimeter-level navigation accuracy during mowing. In this context, the visual quality of the turf often takes priority over the speed at which the task is completed. Furthermore, the industry is increasingly facing labor shortages, making it more difficult to find skilled personnel for these repetitive and precision-driven tasks, further highlighting the need and potential benefit of reliable retrofit automation.

### SUMMARY

According to an aspect, there is provided a system for enabling automated or remote control mode of operation of a machine, the system comprising: one or more actuator apparatuses connectable to one or more machine control components of the machine; a control system operatively connected to the one or more actuator apparatuses, the control system generating control signalling to operate the one or more actuator devices during the automated or remote control mode of operation, wherein the one or more actuator apparatuses comprise a cable actuator apparatus, the cable actuator apparatus comprising: a cable connectable to one of the one or more machine control components; an actuation mechanism coupled to the cable and operable to extend and retract the cable; and a motor connected to the actuation mechanism and controllable to drive the actuation mechanism to extend and retract the cable, wherein, the control system is operable to stop the automated or remote control mode of operation, comprising causing the cable actuator apparatus to extend the cable.

In some embodiments, the stopping the automated or remote control mode of operation is performed for: switching to a manual control mode of operation; or a shutdown process.

In some embodiments, the actuation mechanism comprises a linear actuator.

In some embodiments, the linear actuator comprises a screw mechanism, the screw mechanism converting rotational motion of the motor to linear motion of the cable.

In some embodiments, the actuation mechanism comprises a pulley.

In some embodiments, the control system comprises a safety module that monitors operation of the one or more actuators.

In some embodiments, each of the one or more actuator apparatuses comprises a respective sensor that generates sensor output indicative of a configuration of the actuator apparatus, and the safety module receives the sensor output.

In some embodiments, the cable is movable between fully extended and fully retracted configurations, and controlling the cable actuator apparatus to extend the cable when stopping the automated control mode of operation comprises moving the cable to the fully extended configuration.

In some embodiments, the control system monitors operation of the machine and initiates a shutdown process responsive to detecting a shutdown condition.

In some embodiments, the shutdown process comprises causing the cable actuator apparatus to extend the cable of the cable actuator apparatus.

In some embodiments, the machine comprises a golf turf maintenance machine.

According to another aspect, there is provided a system for enabling automated or remote control of a machine, the system comprising: one or more actuator apparatuses connectable to one or more machine control components of the machine; a control system operatively connected to the one or more actuator apparatuses, the control system generating control signalling to operate the one or more actuator devices during the automated or remote control mode of operation, wherein the one or more actuator apparatuses comprise a rotary actuator apparatus and the one or more machine control components comprises a rotary control component, the rotary actuator apparatus connectable to the rotary control component, the rotary actuator apparatus comprising: a motor controllable by the control system; a first wheel driven by the motor; a first rotary encoder comprising a first encoder disc coupled to the first wheel and a first sensor configured to generate first sensor output modulated by a pattern encoded on the encoder disc; a second wheel coupled to the first wheel for transmission of rotational motion therebetween, the second wheel being rotationally fixed with steering wheel such that rotation of the second wheel rotates the steering wheel; a first rotary encoder comprising a second encoder disc coupled to the second wheel and a second sensor configured to generate second sensor output modulated by a pattern encoded on the second encoder disc, wherein the first wheel has a different size than the second wheel, such that the combination of first and second sensor outputs is readable to provide an angular position of the first wheel over a rotational range exceeding one revolution of the second wheel.

In some embodiments, one full rotation of the second wheel corresponds to a non-integer number of rotations of the first wheel.

In some embodiments, the first wheel comprises a first pulley wheel and the second wheel comprises a second pulley wheel, and the rotary actuator apparatus further comprises a belt coupling the first and second pulley wheels.

In some embodiments, the first wheel comprises a first gear and the second wheel comprises a second gear engaged with the first gear.

In some embodiments, the first encoder disc defines a first modulated outer rim and the first sensor comprises a first optical sensor positioned such that the first modulated outer rim modulates light incident on the first optical sensor as the first wheel rotates.

In some embodiments, the second encoder disc defines a second modulated outer rim and the second sensor comprises a second optical sensor positioned such that the second modulated outer rim modulates light incident on the second optical sensor as the second wheel rotates.

In some embodiments, the first sensor and/or the second sensor may comprise sensing modalities other than optical sensors. For example, the first sensor and/or the second sensor may comprise magnetic sensors (e.g., Hall-effect sensors) configured to detect variations in a magnetic pattern defined on the corresponding encoder disc, capacitive sensors configured to detect changes in capacitance associated with encoded features, inductive sensors, or other contactless sensing technologies. In such embodiments, the encoder discs may include corresponding magnetic, conductive, or structural patterns adapted to interact with the selected sensing modality, thereby enabling determination of angular position independently of optical detection.

According to another aspect, there is provided controller for a machine having an automated or remote mode of operation and a manual mode of operation, the machine comprising a cable actuator apparatus operable connected to a machine control component, the cable actuator apparatus being operable to extend and retract a cable to thereby actuate the machine control component, the controller comprising: one or more processors; and memory having stored thereon processor-executable instructions that, when executed, cause the one or more processors to implement a method comprising: receiving input triggering stopping the automated or remote control mode of operation; and responsive to receiving the input, controlling the cable actuator apparatus to extend the cable.

In some embodiments, the controller is configured to monitor operation of the machine and initiate a shutdown process responsive to detecting a shutdown condition.

In some embodiments, the shutdown process comprises causing the cable actuator apparatus to extend the cable of the cable actuator apparatus.

According to another aspect, there is provided a method for automated or remote machine control as described herein. The method may comprise receiving input triggering stopping the automated or remote control mode of operation; and responsive to receiving the input, controlling a cable actuator apparatus to extend a cable of the cable actuator.

Other aspects and features of the present disclosure will become apparent to those ordinarily skilled in the art upon review of the following description of the specific embodiments of the disclosure.

### BRIEF DESCRIPTION OF THE DRAWINGS

The present disclosure will be better understood having regard to the drawings in which:

FIG. 1 is a side view of an example golf turf maintenance vehicle;

FIG. 2 is a functional block diagram of an example machine retrofitted comprising one or more actuator apparatuses according to some embodiments;

FIGS. 3A to 3C are perspective views of an example cable actuator apparatus according to some embodiments;

FIGS. 4A to 4D are perspective views of another example cable actuator apparatus according to some embodiments;

FIGS. 5A to 5D are perspective views of an example rotary actuator apparatus according to some embodiments; 5E is a top view of the rotary actuator apparatus of FIGS. 5A to 5D;

FIGS. 5F and 5G are additional perspective views of the rotary actuator apparatus of FIGS. 5A to 5E;

FIG. 5H is a perspective view of the actuator apparatus of FIGS. 5A to 5G installed on a steering column with a steering wheel attached;

FIGS. 6A to 6C are perspective views of another example rotary actuator apparatus according to some embodiments;

FIG. 7 is a functional block diagram of an example control system 210 according to some embodiments;

FIG. 8 is a flowchart of a method according to some embodiments.

### DETAILED DESCRIPTION

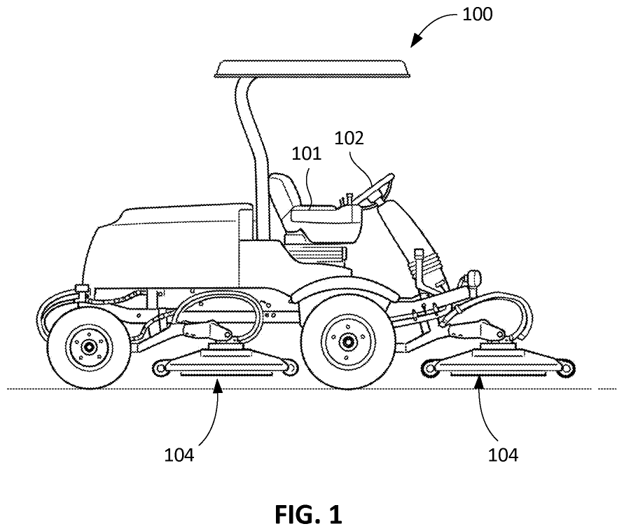

FIG. 1 is a is a side view of an example golf turf maintenance machine 100. The machine 100 is a vehicle including a seat 101 for an operator, typical manual controls for navigation, such as a steering wheel 102 (connected to a steering column), throttle, brake, engine start and stop controls, and more. The machine 100 may also include controls for the equipment 104. The machine 100 may typically be driven over the turf to perform the associated maintenance task.

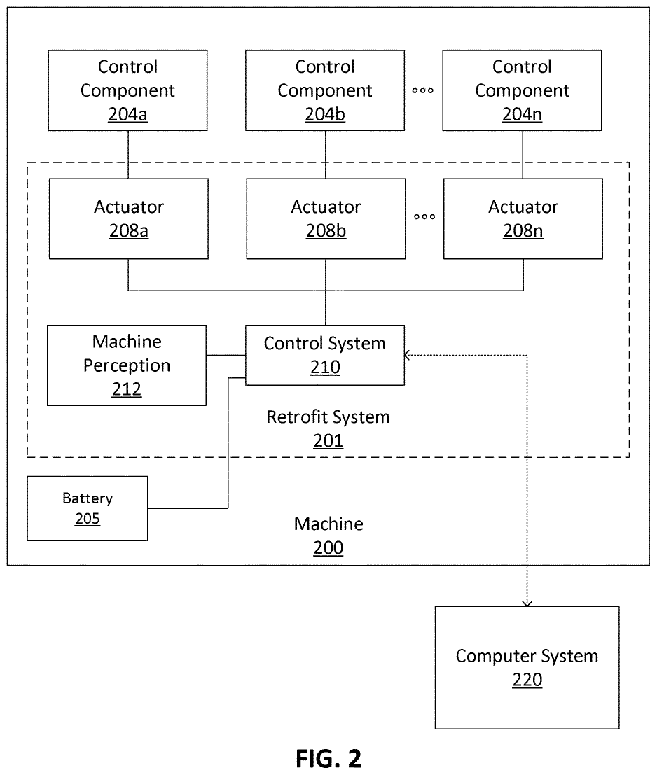

FIG. 2 is a functional block diagram of the example machine 200 retrofitted with a retrofit system 201 according to some embodiments. The retrofit system 201 may be installed to enable automated or remote operation of the machine. In other embodiments, rather than being retrofitted with components of the system 201, the machine 200 may be originally built with such components.

The machine 200 in this example is a vehicle with equipment for golf turf maintenance (similar to the machine 100 in FIG. 1), for example, although embodiments of this disclosure may be applied to other types of machines. Some embodiments are described below with reference to the example machine 200 for illustrative purposes. However, it is to be understood that embodiments are not limited to the specific machine 200 shown in FIG. 2, or to golf turf maintenance machines.

The machine 200 in this example includes control components 204a to 204n. The control components 204a to 204n may include one or more of: a rotary control component, such as a steering wheel or steering shaft, a throttle, a brake component, engine start/stop controls, and/or other control component(s) for controlling other operational aspects of the vehicle. For example, the additional control components 204a to 204n may include controls for operating the golf turf equipment of the machine, such as mowing or golf ball picking equipment. The machine 200 also includes a battery 205 in this example. The skilled person will appreciate that the machine 200 will typically include other equipment not specifically shown in FIG. 2, such as an engine or motor (e.g. electric or gas powered), wheels or other locomotion means, etc.

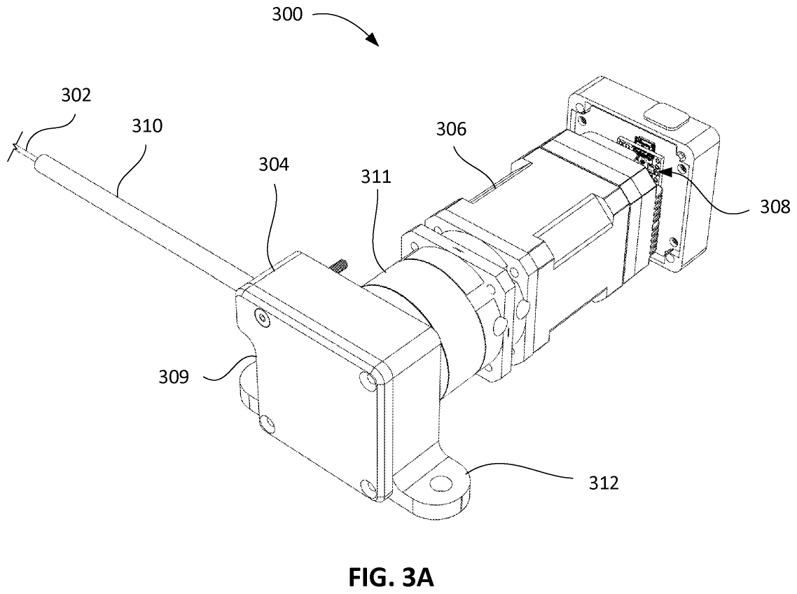

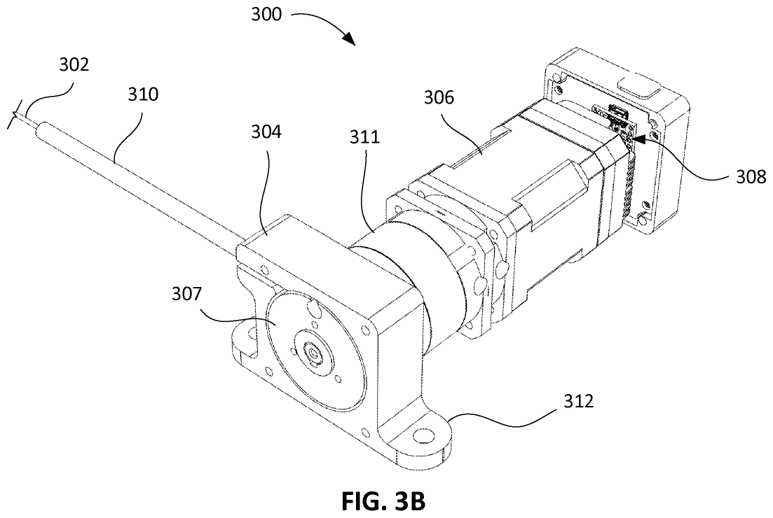

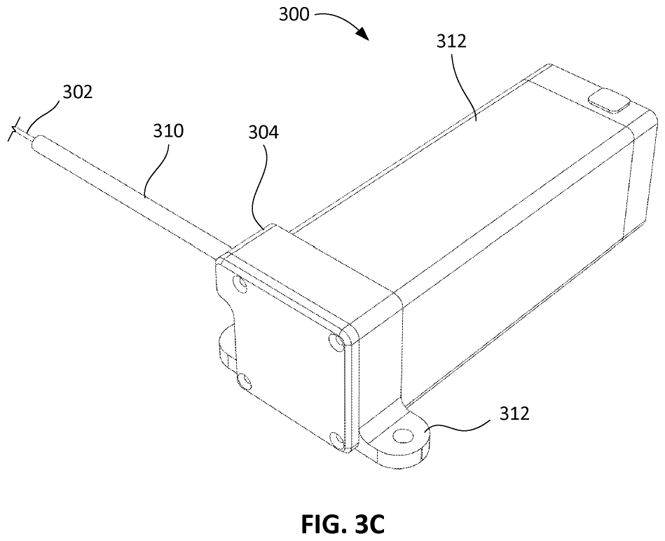

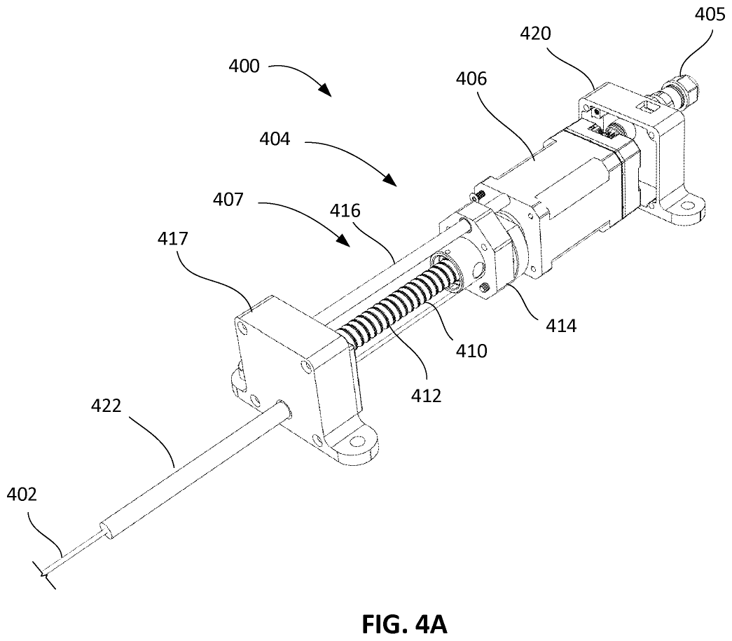

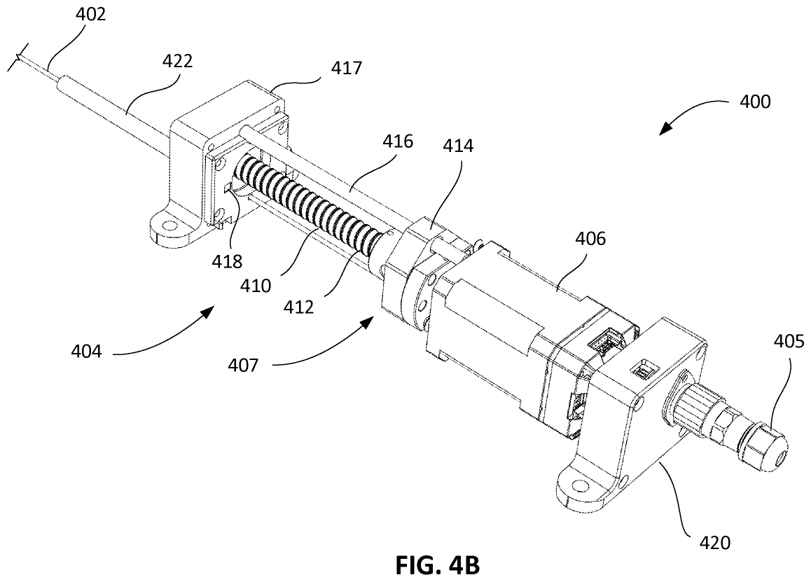

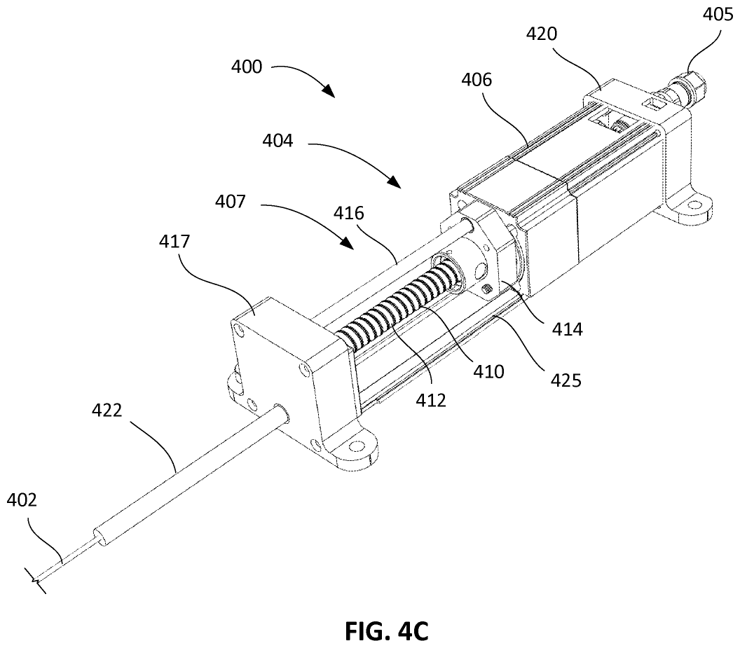

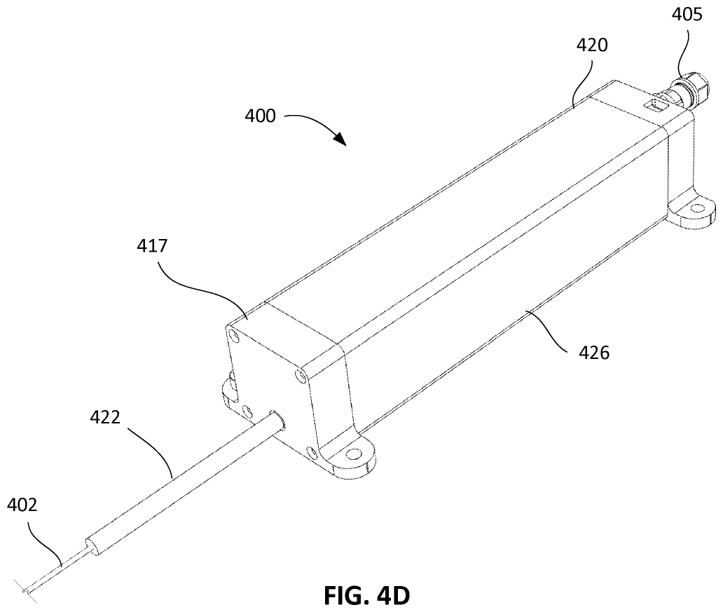

The retrofit system 201 in this example includes one or more actuator apparatuses 208a to 208n coupled to the 204a to 204n control components of the machine 200. For example, in some embodiments, one of the control components 204a to 204n is a steering wheel and one of the actuator apparatuses 208a to 208n is a steering actuator coupled to the steering wheel. Example steering actuators are shown in FIG. s 5A to 6C and described below. In some embodiments, one or more actuator apparatuses 208a to 208n of the retrofit system may be cable-based actuator apparatuses (referred to as “cable actuators apparatuses” herein) such as one or more of those described below with reference to FIGS. 3A to 4D. A combination of the example actuator apparatuses shown in FIGS. 3A to 6C and/or other types of actuator apparatuses may also be used to actuate the various control components 204a to 204n of the machine 200.

The retrofit system 201 further includes a control system 210 operatively connected to the one or more actuator apparatuses 206 and 208a to 208n. The control system 210 generates control signalling to operate the one or more actuator apparatuses 208a to 208n during an automated or remote control mode of operation.

As will be described below, cable actuator apparatuses (such as those described below with reference to FIGS. 3A to 4D) may include a cable coupled to a control component (204a to 204n) of the machine 200, where the cable is actuatable to move the control component. The cable actuator apparatus may extend and retract the cable, where physical force to move the control component comprises pulling on the control component by retracting the cable. Two cable actuators may be connected to the same control component. A first of the two cable actuators may pull the control component in a first direction, and a second of the two cable actuators may pull the control component in a second, opposite direction. The cables may be movable between a fully retracted and fully extended configurations. The term “fully extended” and “fully retracted” may refer to the normal operating ranges of cable movement for controlling the machine, and does not necessarily require a physical stop or limitation of the cable actuator. Retracting the cable may place tension on the corresponding control component (e.g. brake or throttle) to actuate that component.

In a manual mode of operation, or in shut down, the cable actuators may be extended. For example, when switching from automated or remote control of the machine (i.e. control by the retrofit system 201), and/or when shutting down, the control system 210 may cause some or all of the cable actuator apparatuses (of the actuator apparatuses 208a to 208n) to extend the corresponding cables. The cables may be extended to their fully extended configurations. By proactively extending the cables for manual operation of the machine 200, an operator may manually manipulate controls (e.g. throttle, etc.) without back driving the cable actuator apparatuses and/or without interference from pulling on the cables.

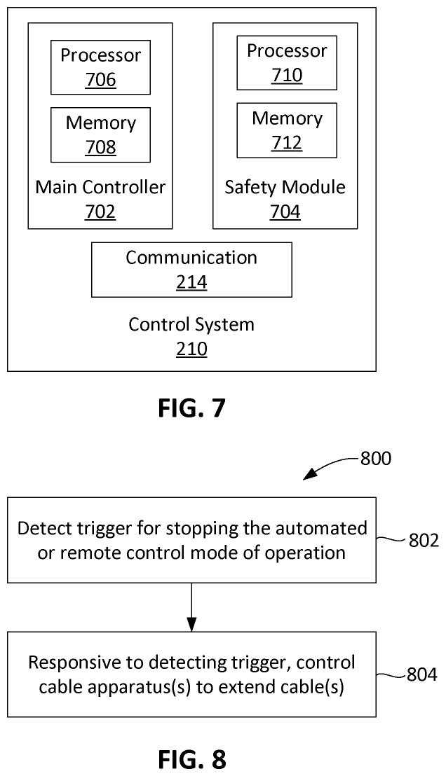

The retrofit system 201 may further include communication components 214, such as one or more transceivers (receivers and/or transmitters) or other equipment for communication with other devices over a network such as the Internet. By way of example, the control system 210 includes communication components 214 (shown in FIG. 7) that may allow the control system 210 to communicate with a remote computer system 220. In some embodiments, the communication components 214 are external from the control system 210. The remote computer system may run a software platform, such as a dashboard program, that communicates with the machine 200 (via control system 210). The dashboard program may provide functionality including, but not limited to, one or more of: monitoring of operation of the machine; remote operation of the machine 200; analytics; and more.

The retrofit system 201 may further include components such as one or more machine perception components 212. The machine perception components 212 may include, but are not limited to, one or more of: optical sensors (e.g. RGB-D depth camera(s), and/or IR and thermal cameras, etc.) positional sensors such as GNSS receivers (e.g., GPS, Galileo, GLONASS, BeiDou, etc.) inertial measurement units (IMUs), or other sensors for monitoring the environment and/or machine operation.

The elements of the retrofit system 201 described herein may be powered by the battery 205 of the machine. The retrofit system 201 may, thus, not require an additional power source to be added to the machine 200. In other embodiments, the retrofit system may include one or more power sources. Embodiments are not limited to the specific configuration shown in FIG. 2.

The use of cable-based actuators may have one or more advantages or benefits in the context of retrofitting vehicles or other machines for remote and/or automated control, and particularly for golf turf maintenance machines. Golf clubs and their clientele may be sensitive to fluid leaks on the turf. The cable actuators described herein do not require hydraulic fluid, and thus, adding the cable actuators may not require installing additional hydraulic components that could increase the chances of fluid leaks. Additionally, the use of cables may provide flexibility for placement of the motor and actuator mechanism, since a long cable may follow a path between the actuation mechanism and the corresponding control component of the machine. For example, a box housing multiple actuator apparatus'motors and actuation mechanisms may be mounted on a side or top of the machine 200 with cables extending to the various corresponding control components 204a to 204n.

FIGS. 3A to 3C are perspective views of an example cable actuator apparatus 300 according to some embodiments. With reference to FIGS. 3A and 3B, the cable actuator apparatus 300 comprises a cable 302 (partially shown), an actuation mechanism 304, and a motor 306. The cable 302 is connectable to a control component of the machine 200 of FIG. 2. For example, a distal end (not shown) of the cable 302 may be connected to a throttle level, brake lever, switch, or other vehicle control component, such that contracting the cable 302 actuates the lever.

The actuation mechanism 304 coupled to the cable 302 and operable to extend and retract the cable 302. The actuation mechanism 304 in this example comprises a pulley 307 (FIG. 3B). The cable 302 may be partially wrapped around the pulley 307, such that rotation of the pulley 307 in a first direction retracts the cable 302 (i.e. the cable 302 becomes further wrapped around the pulley 307, thereby shortening the length of the portion of the cable 302 extending from the pulley 307). Rotation of the pulley 307 in a second, opposite direction extends the cable 302 (i.e. the cable 302 at least partially unwraps from the pulley 307, thereby increasing the length of the portion of the cable 302 extending from the pulley 307). FIG. 3A shows an optional cover 309 that covers a side of the actuation mechanism 304. In FIG. 3B, the cover 309 is removed so that the pulley 307 is visible. The cable actuator apparatus 300 may include one or more sensors. For example, the cable actuator apparatus 300 may include a proximity sensor (not shown) for determining or monitoring the position of the pulley 307. The proximity sensor may also be used for homing the pulley 307. The proximity sensor may detect when the pulley 307 is in its initial start position. When the actuator apparatus 300 is first powered on, the actuator assembly 300 may perform an initialization sequence including driving the pulley 307 to extend the cable 302 until the pulley 307 reaches this initial start position. From that point onward, movement of the pulley 307 may be tracked by a motor encoder (not shown) or other monitoring sensor of the cable actuator apparatus 300.

The motor 306 is connected to the pulley 307 and controllable to drive the pulley 307 to extend and retract the cable 302. The motor 306 in this example is an electric motor 306 that receives power from the battery 205 of the machine 200. The motor 306 may rotate an axle (not visible) that interconnects the motor 306 and pulley 307, such that rotation of the axle rotates the pulley 307. The motor 306 may be connected directly to the pulley 307 or via a gearbox 311, such as a planetary or other type of speed reducer, configured to increase torque. The motor 306 may be capable of bi-directional rotation direction (i.e. rotation in forward and reverse directions for extending and retracting the cable).

The cable actuator apparatus 300 further comprises electronic components 308 coupled to the motor. The electronic components 308 may comprise communication components operable to receive control signalling from the control system 210 shown in FIG. 2, for controlling the motor 306. The electronic components 308 may further include electronics for transmitting information to the control system 210. The cable actuator apparatus 300 may further include one or more sensors for monitoring operation of the cable actuator apparatus 300. For example, the sensor(s) may monitor the position of the pulley 307. The sensor(s) may also measure temperature, stress or other operational parameters. Measurement data from the sensor(s) may be transmitted back to the control system 210 in FIG. 2.

The actuation apparatus 300 further includes a sleeve 310 that at least partially surrounds the cable 302, forming a Bowden-type cable assembly. The sleeve 310 functions as a substantially non-compressible, load-bearing outer conduit, while the inner cable 302 may translate axially within the sleeve with minimal friction. The sleeve 310 is mounted to a fixed structure at the remote end relative to the actuation mechanism 304. In operation, when a tensile force is applied to the inner cable 302, the corresponding reaction force is transmitted through the sleeve 310 to the fixed structure. This configuration enables the transmission of mechanical force over a distance while isolating the actuation apparatus 300 from tensile loads, thereby improving positional stability and control accuracy. Additionally, the flexible nature of the Bowden-type cable assembly permits routing around structures or through confined spaces, which would be impractical with rigid mechanical linkages. This may simplify system integration and reduce mechanical complexity. The sleeve 310 may be constructed from a coiled steel structure or other flexible, low-friction, compression-resistant materials, allowing the assembly to follow curved paths while maintaining structural integrity and minimizing deformation under load.

The cable 302 may comprise a metal wire or any other suitable type of cable capable of handling expected forces and stresses associated with actuating the machine control component. The motor 306 may be selected to provide sufficient speed and torque to actuate the associated machine control component. In some embodiments, an optional reducer (e.g., gearbox) may be installed between the motor 306 and pulley 307 to meet specific torque and speed requirements, potentially allowing for optimization based on the application's performance needs.

The actuator apparatus 300 may be secured to the machine in any suitable manner. For example, the apparatus 300 may include a mounting bracket 312 or another securing means.

FIG. 3C shows an optional outer housing 312 of the cable actuator apparatus 300. The outer housing 312 is removed in FIGS. 3A and 3B.

The apparatus 300 may communicate with the control system 210 of the machine 200 (FIG. 2) via wired or wireless communication.

FIGS. 4A to 4D are perspective views of another example cable actuator apparatus 400 according to some embodiments. With reference to FIGS. 4A and 4B, the cable actuator apparatus 400 comprises a cable 402 (partially shown), an actuation mechanism 404, and a motor 406. The cable 402 is connectable to a control component of the machine 200 of FIG. 2. For example, a distal end (not shown) of the cable 402 may be connected to a throttle lever, brake lever, or other vehicle control component, such that contracting the cable 402 actuates the control component.

The actuator mechanism 404 in this embodiment comprises a linear actuator 407 (such as a ball screw or lead screw actuator) that transforms rotational motion from the motor 406 into linear motion. The linear actuator 407 in this particular example is a ball screw actuator comprising a screw 410 with outer threads 412 and a nut 414 with inner threads (not shown) that is engaged with the screw 410. The nut 414 is rotationally fixed, such that rotation of the screw 410 causes a corresponding linear movement of the nut 414 (parallel with the longitudinal axis of the screw 410) constrained by of the guide bar 416. An end frame piece 417 is connected to the distal end of the screw. The cable 402 extends through the end frame piece 417 and connects to the nut 414, such that the linear movement of the nut 414 extends and retracts the cable 402.

The cable actuator apparatus 400 may further comprise electronic components within an electronics compartment 420 that are coupled to the motor 406. The electronic components may, for example, comprise communication components operable to receive control signalling from the control system 210 shown in FIG. 2, for controlling the motor 406. The electronic components may further include electronics for transmitting information to the control system 210.

The cable actuator apparatus 400 may include one or more sensors for monitoring operation and/or position of the cable actuator apparatus 400. In this example, the actuator apparatus 400 also includes a proximity sensor 418 (visible in FIG. 4B) used for homing the actuator. The sensor may be triggered when the nut 414 reaches its initial starting position towards the frame piece 417, setting the origin of the movement during the initialization sequence. From that point forward, the actuator's movement may be tracked precisely using the motor encoder mounted at the back of the motor. Measurements from the sensor 418 may be transmitted back to the control system 210 in FIG. 2. Optionally, the apparatus 400 may include one or more other sensors that measure properties such as temperature and/or torque, to name a couple examples.

The actuation device 400 further includes a sleeve 422 over the cable 402 that may be mounted to a fixed structure at the remote end. The sleeve 422 may enable efficient force transmission over a distance by providing a constrained, non-compressible pathway for the inner cable 402. The sleeve 422 might be constructed from coiled steel or other flexible yet rigid materials, to allows for flexible routing without collapsing under load. It may transmit the reaction force generated when the inner cable 402 is pulled, all while potentially minimizing friction and maintaining structural integrity. The cable 402 may comprise a metal wire or any other suitable type of cable capable of handling expected forces and stresses associated with actuating the machine control component. The motor 406 may be selected to provide sufficient power (speed and torque) to actuate the associated machine control component.

FIG. 4C shows the cable actuator apparatus 400 with a motor housing 424 around the motor 406 and a divider 425 that keeps electrical cables out of the way of the moving parts, extending from the end frame piece 417 to the motor housing 424. FIG. 4D shows an outer housing 426 over the motor 406, motor housing 424 and actuation mechanism 404 (linear actuator 407) that were visible in FIGS. 4A and 4B. The outer housing extends between the electronics compartment 420 and the end frame piece 417 in this example. Other configurations may be used in other embodiments.

Cable actuator apparatuses including a linear actuator (such as the example actuator apparatus 400 in FIGS. 4A to 4D) may provide greater torque (using the same battery power source) than pulley-based actuator apparatuses. Other types of linear actuators may be used in other embodiments.

The apparatus 400 may communicate with a control system, such as the control system 210 of the machine 200 in FIG. 2, via wired or wireless communication. FIGS. 4A to 4D shows a communication port 405 that may used for a wired connection to a control system (such as the control system 210 in FIG. 2). The apparatuses described herein may be in bi-directional communication with the control system 210 via a data bus (CAN bus), as one example.

Embodiments are not limited only to the particular configuration of the cable actuators 300 and 400 shown in FIGS. 3A to 4D. The actuator apparatuses may have additional features or omit features of FIGS. 3A to 4D in other embodiments.

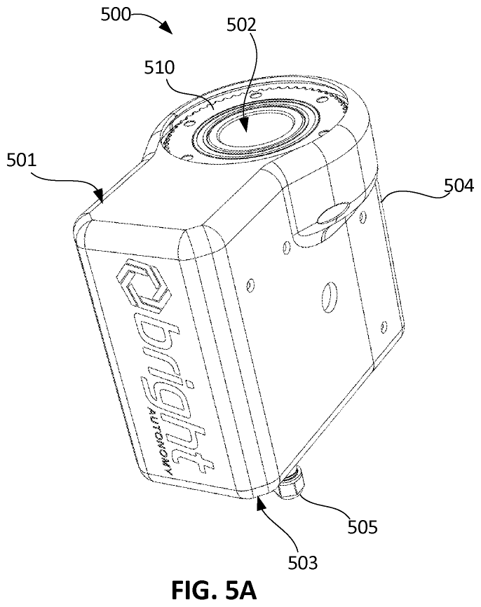

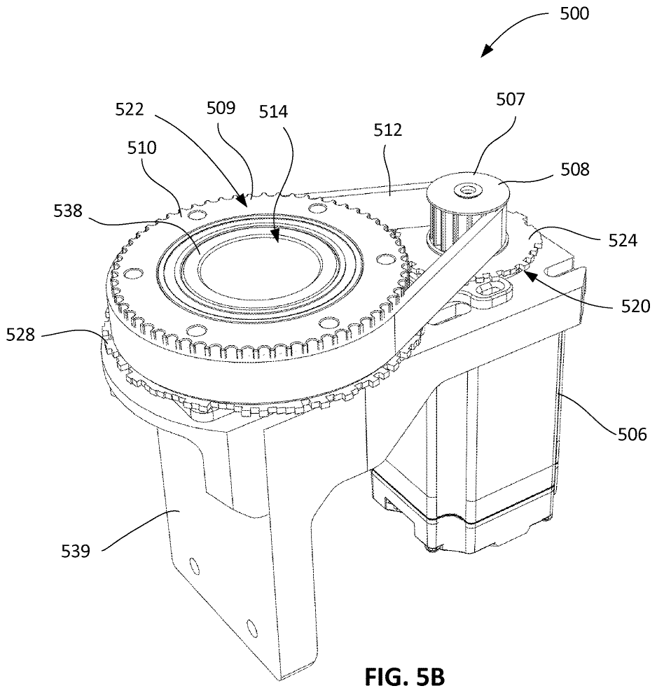

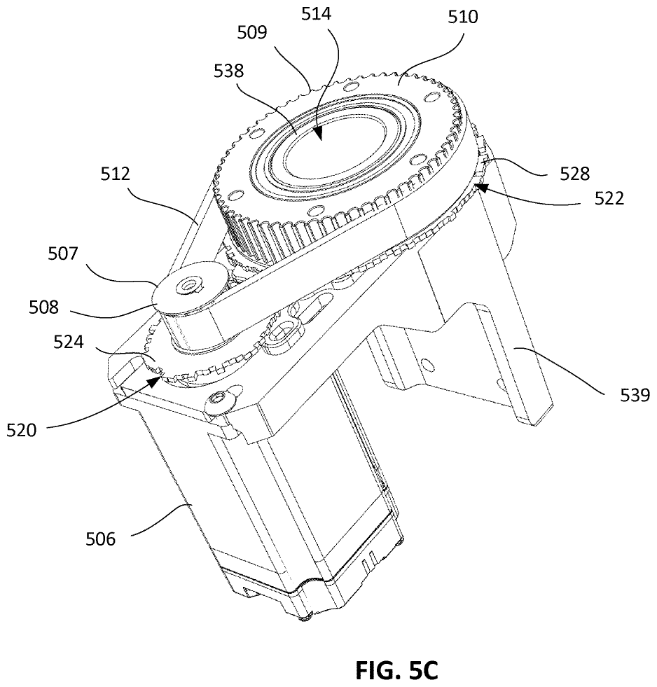

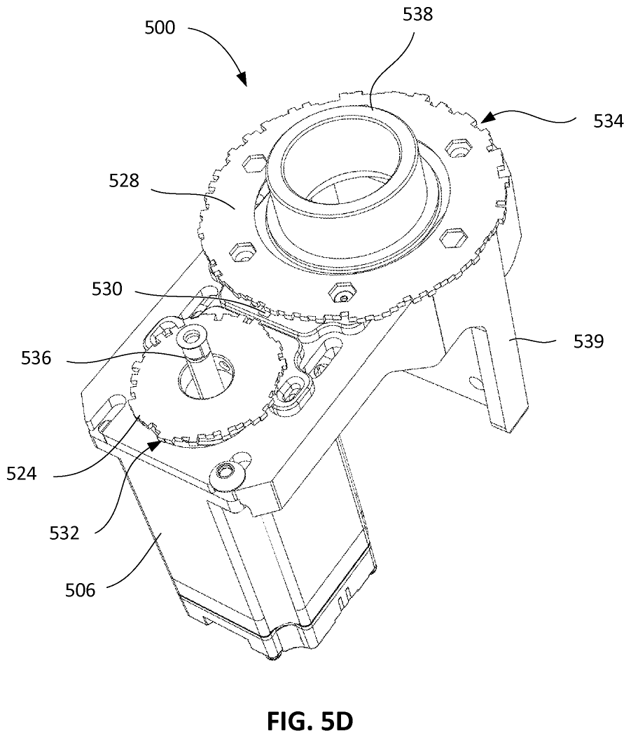

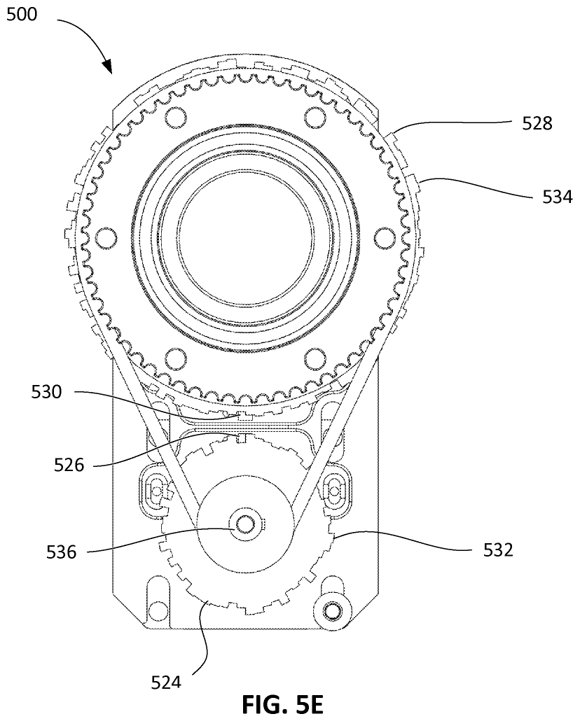

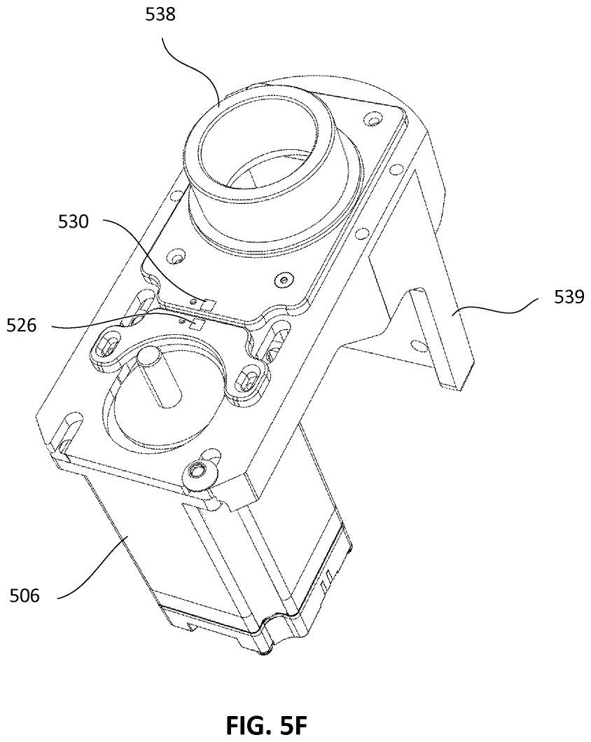

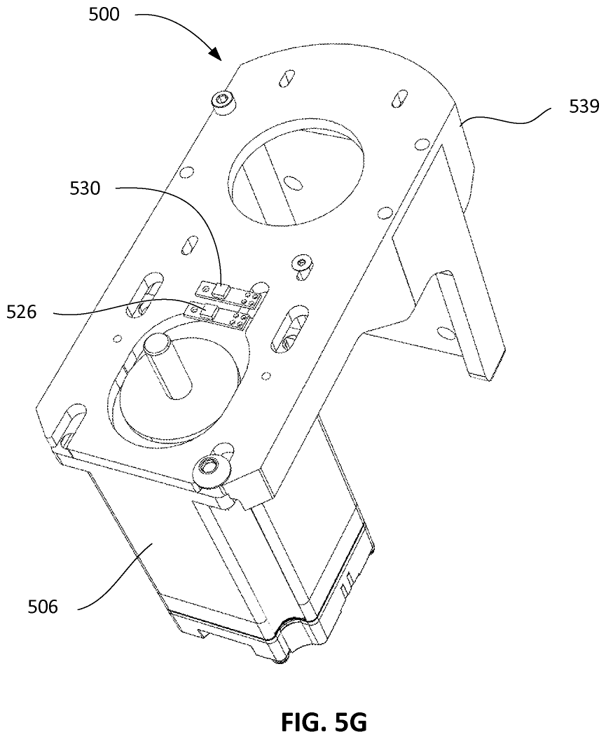

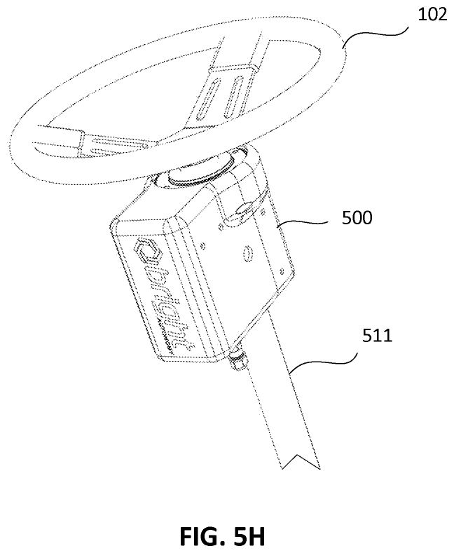

FIGS. 5A to 5G illustrate an example rotary actuator apparatus 500 according to some embodiments. The rotary actuator apparatus 500 is configured for actuating a steering wheel in this example. The actuator apparatus 500 may be attached directly to a shaft component (i.e. steering column) of the steering wheel or to a coupling (not shown) that is attached to the steering wheel. One of the actuator apparatuses 208a to 208n of FIG. 2 may be in the form of the actuator apparatus 500 of FIGS. 5A to 5G.

FIG. 5A is a perspective view of the rotary actuator apparatus 500. The apparatus 500 defines a passage 502 therethrough (from a top 501 to a bottom 503 of the actuator apparatus 500 in this example). A steering column 511 (see FIG. 5H) may be received through the passage 502, serving as a structural mounting support. The apparatus 500 includes an outer housing 504 in this example.

FIGS. 5B and 5C are perspective views of the rotary actuator apparatus 500 of FIG. 5A with the outer housing 504 removed to show some internal components of the apparatus 500.

The rotary actuator apparatus 500 in this embodiment comprises a motor 506, a first wheel assembly 507 comprising a first wheel 508 and a second wheel assembly 509 comprising a second wheel 510 coupled to the first wheel 508. The term “coupled to” in this context does not necessarily require direct engagement. In the embodiment of FIGS. 5A to 5G, the first and second wheels 508 and 510 are pulley wheels coupled by a belt 512. In other examples, the wheels may instead be cogwheels coupled by a chain, or the wheels may instead be gearwheels that are directly engaged (i.e. engaged gear teeth). The first wheel assembly 507 is coupled to the motor 506, such that the motor 506 drives rotation of the first wheel 508. A central hole 514 though the second wheel assembly 509 forms part of the passage 502 shown in FIG. 1. Rotation of the first wheel 508 is transferred to the second wheel 510 by the belt 512, to thereby rotate the steering wheel.

The motor 506 may be controlled by the control system 210 of FIG. 2, for example, to steer the machine 200. For automated or remote navigation of a machine, it may be important to know the current angle of the wheels (and by extension, the current angular position of the steering wheel.

The actuator apparatus 500 includes a first rotary encoder 520 and a second rotary encoder 522. Each rotary encoder 520 and 522 allows determination of the absolute angle of a respective one of the wheel assemblies 507/509. The first rotary encoder 520 comprises a first encoded disc 524 and a first optical sensor 526 (shown in FIGS. 5E to 5G). The second rotary encoder 522 comprises a second encoded disc 528 and a second optical sensor 530 (shown in FIGS. 5D to 5G). Each optical sensor 530 may include a phototransistor and an LED, for example. The phototransistor may measure intensity of light from the LED that is reflected back to the phototransistor.

In this embodiment, the first encoder disc 524 defines a first modulated outer rim 532, and the first optical sensor 526 positioned such that the first modulated outer rim 532 modulates light incident on the first optical sensor 526 as the first wheel assembly 507 rotates. The second encoder disc 528 defines a second modulated outer rim 534, and the second optical sensor 530 positioned such that the second modulated outer rim 534 modulates light incident on the second optical sensor 530 as the second wheel assembly 509 rotates. The modular outer rims 532/534 are modulated as a readable code, and the modulated signal output from each of the sensors 526/530 allows is readable and may indicate the current absolute angular position of the corresponding wheel assembly 507/509. The encoding (e.g., edge modulation) of the outer rims 532 and 534 may generate optical signals that allow determination of the angular positions of the wheels 508/510 based on a small amount of movement of the wheels 508/510. The position may be determined after a short movement using a pattern-matching algorithm executed within the actuator's electronic control unit. In some embodiments, movement of approximately 15 degrees or less of the second encoder disc 328 may be sufficient to determine its position.

While the rotary encoders 520 and 522 are described herein as employing optical sensors, other sensing modalities may be used to detect rotation and determine angular position. For example, the sensors 526/530 may alternatively comprise magnetic sensors (e.g., Hall-effect sensors) configured to detect variations in a magnetic pattern on the encoded discs 524/528, capacitive sensors configured to detect changes in capacitance associated with encoded features, inductive sensors, or other contactless sensing technologies. In such embodiments, the encoded discs 524/528 may include corresponding magnetic, conductive, or structural patterns adapted to interact with the selected sensing modality. These alternative implementations may provide improved robustness to environmental conditions such as dirt, moisture, or lighting variations, while maintaining the ability to determine absolute angular position of the wheel assemblies 507/509.

A steering wheel may have a range of motion for steering that includes multiple rotations (i.e. more then 360 degrees). It may be beneficial to know the angular position of the steering wheel over a range including multiple rotations (e.g. over four rotations or more). In this embodiment, the first wheel 508 has a different size than the second wheel 510, such that the combination of angular positions of the first and second wheels 508/510 is unique for multiple revolutions of the second wheel 510. Thus, the combination of first and second optical sensor outputs provides an indication of the position of the second wheel 510. For example, one wheel 508/510 may have a size that is a non-integer multiple of size of the other wheel 508/510, to provide a size ratio such that, starting from an initial combined alignment, the second wheel 510 must move through multiple revolutions before the initial combined alignment of the wheels 508/510 is repeated.

FIG. 5D is a perspective view of the rotary actuator apparatus 500, in which the first and second wheels 508 and 510 and the belt 512 have been removed to better show the first and second encoder discs 524 and 530. The axel 536 of the motor 506 and a bushing 538 of the second wheel assembly 509 are visible in FIG. 5D. The motor 506, wheel assemblies 507/509, optical sensors 526/530 and bushing 538, are mounted to a frame 539 in this embodiment, but embodiments are not limited to the specific arrangement shown in FIGS. 5A to 5G.

FIG. 5E is a top view of the rotary actuator apparatus 500 of FIGS. 5B and 5C. Both the first optical sensor 526 and the second optical sensor 530 are visible in FIG. 5E.

FIG. 5F is a perspective view of the rotary actuator apparatus 500 of FIG. 5D with the encoder discs 524 and 528 removed.

FIG. 5G is a perspective view of the rotary actuator apparatus 500 of FIG. 5F with the optical sensors 526 and 530 and the bushing 536 removed.

FIG. 5H shows the actuator apparatus 500 installed on a steering column 511 with the steering wheel 102 attached.

Turning again to FIG. 5A, the apparatus 500 may also include electronics similar to the other example actuator apparatuses described herein. FIG. 5A shows a communication port 505 that may used for a wired connection to a control system (such as the control system 210 in FIG. 2). Similar to the examples of FIGS. 3A to 4D, the rotary actuator apparatus 500 may receive control signaling from the control system and transmit data to the 526/530 may control system. For example, the outputs from the optical sensors be transmitted back to the control system 210 to allow the control system to determine the angular position of the steering wheel.

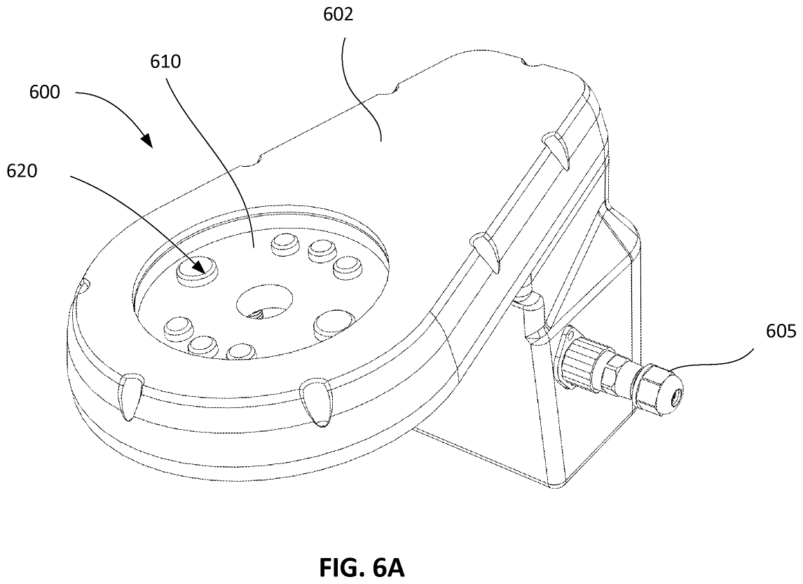

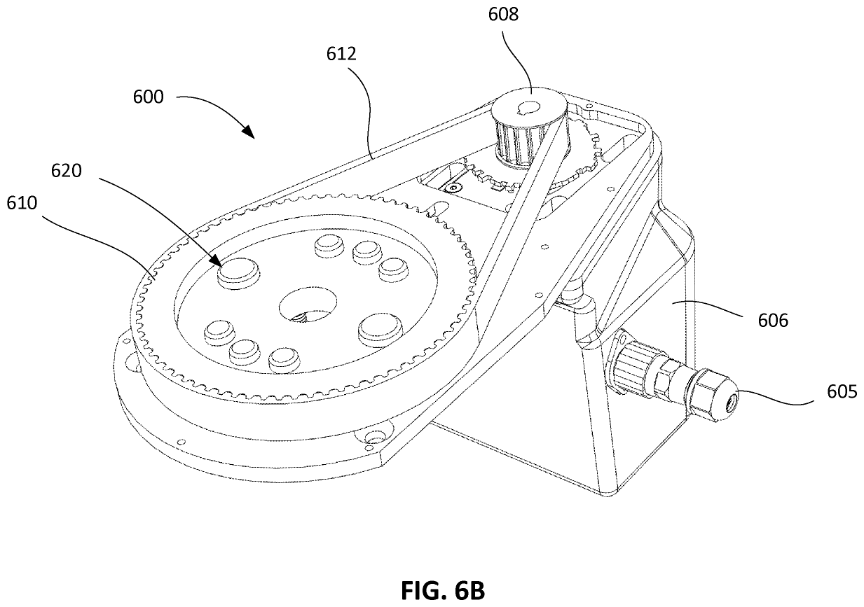

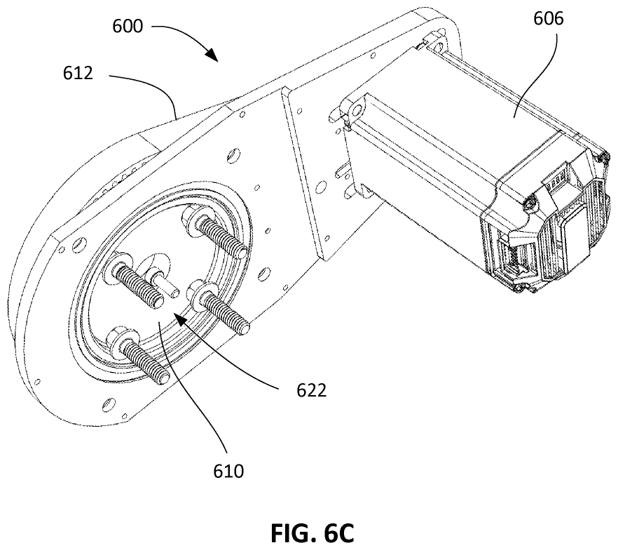

FIGS. 6A to 6C are perspective views of another rotary actuator apparatus 600 according to some embodiments. The actuator apparatus 600 in this embodiment is similar to the apparatus 500 in FIGS. 5A to 5G in that it includes a motor 606 and first and second wheels 608 and 610 coupled by a belt 612, where the first wheel 608 is driven by the motor 506. However, the rotary actuator apparatus 600 is configured to be mounted for installation on machines without a steering column, in which the steering wheel is directly coupled to the hydraulic steering valve. The bottom face (underside) 622 of the second wheel 610 is visible in FIG. 6C. The bottom face 622 in this embodiment is configured to be secured on top of hydraulic steering valve case (not shown) the upper face 620 of the second wheel 610 is configured to have a steering wheel mounted thereto.

The rotary actuator apparatuses 500 and 600 in FIGS. 5A to 6C may allow manual steering of the machine (e.g. machine 200 in FIG. 2) when automated or remote control of the machine is not active (i.e. in a manual mode of operation). The motors 506/606 may allow manual movement when the motors 506/606 are not energized.

FIG. 6A shows a communication port 605 that may be used for a wired connection to a control system (such as the control system 210 in FIG. 2). The rotary actuator apparatus 600 may receive control signaling from the control system and transmit data to the control system.

FIG. 7 is a functional block diagram of and example implementation of the control system 210 of the machine 200 in FIG. 2. In this example, the control system includes a main controller 702 and a safety module 704. The main controller may comprise one or more processors 706 and memory 708 operatively connected to the one or more processors 706. The memory 708 may store processor-executable instructions that, when executed by the one or more processors 706 cause the one or more processors 706 to preform one or more of the methods described herein, such as the method 800 of FIG. 8 described below. In some embodiments, the control system 210 may perform control functionality including (but not limited to) one or more of: analyzing data received from components of the retrofit system 201 (FIG. 2) such as the machine perception components 212 and actuator apparatuses 208a to 208n (FIG. 2); communication with the remote computer system 222 (via communication components 214); controlling the actuator apparatuses 208a to 208n for automated or remote control of the machine 200 etc.

The safety module 704 in this example includes an additional one or more processors 710 and memory 712 operatively connected to the one or more processors 710. The memory 712 may store processor-executable instructions that, when executed by the one or more processors 710 cause the one or more processors 710 to preform control functionality including (but not limited to) one or more of: monitoring positions or other operational parameters of the actuator apparatuses 208a to 208n. The safety module 704 may receive output from sensors of the actuator apparatuses 208a to 208n. The sensors may generate output indicative of the position or configuration of the actuator apparatuses 208a to 208n. The safety module 704 may also monitor other operational parameters of the actuator apparatuses 208a to 208n, such as whether the actuator apparatuses 208a to 208n are maintaining proper communication with the control system 210, current position, temperature, torque, stress, error codes, etc.

If the safety module 704 determines that one or more of the actuator apparatuses 208a to 208n is not operating properly, or is operating outside of an acceptable range, the safety module 704 may initiate an automated or remote operation shutdown process. The process may include stopping the machine 200 by activating a brake of the machine and/or turning off the machine. The safety module 704 may cut power to one or more actuator apparatuses 208a to 208n.

The safety module 704 may cause cable actuators (of the actuator apparatuses 208a to 208n) to extend their cables upon either: switching from automated/remote control to manual mode of operation; or initiating a shutdown process. Upon receipt of a shutdown command at the control system 210, for example, the safety module 704 may stays on long enough to perform a shutdown process including extending the cables.

The safety module 704 may perform other safety functions in response to input collected by the control system 210 including, but not limited to, braking (e.g. if the machine is headed off course or experiencing other navigation issues), shutting down the machine upon detection of a shutdown condition; issuing an alert message; etc. The safety module 704 may be in communication with both the main controller 702 and the actuators 208a to 208n.

FIG. 8 is a flowchart of an example method 800 that may be performed or implemented, for example, by the control system 210. At block 802, a trigger for stopping the automated or remote control mode of operation is detected. This step may comprise receiving input (e.g. from a remote computing device) including a command to stop the automated or remote control mode of operation. The input may, for example, be received from a remote computing system. The input may be received by a user input device of the machine (e.g. via a user interface). In some embodiments, the control system 210 may monitor operation of the machine and initiate a shutdown process responsive to detecting a shutdown condition. Detecting the trigger may comprise detecting the shutdown condition.

At block 804, responsive to detecting the trigger, one or more cable actuator apparatuses (such as one of the apparatuses described herein) is controlled to extend the cable. Other steps may also be taken in response to detecting the trigger, including, but not limited to: shutting down the machine; sending an alert for receipt by another computing device; shutting down power to one or more actuator devices; etc. The method may also include performing one or more other functions described herein.

Elements referred to herein in the singular may be plural and vice versa, except wherein indicated otherwise either explicitly or inherently by context. As used herein the terms “a,” “an”, and “the” may include plural referents unless the context clearly dictates otherwise. As used herein, the term “coupled” are intended to encompass components that are directly connected to one another as well as components that are indirectly connected with one or more other components therebetween, unless the context clearly dictates otherwise.

It is to be understood that a combination of more than one of the approaches described above may be implemented. Embodiments are not limited to any particular one or more of the approaches, methods or apparatuses disclosed herein. One skilled in the art will appreciate that variations, alterations of the embodiments described herein may be made in various implementations without departing from the scope of the claims.

1. A system for enabling automated or remote control mode of operation of a machine, the system comprising:
one or more actuator apparatuses connectable to one or more machine control components of the machine;
a control system operatively connected to the one or more actuator apparatuses, the control system generating control signalling to operate the one or more actuator apparatuses during the automated or remote control mode of operation, wherein the one or more actuator apparatuses comprise a cable actuator apparatus, the cable actuator apparatus comprising:
a cable connectable to one of the one or more machine control components;
an actuation mechanism coupled to the cable and operable to extend and retract the cable; and
a motor connected to the actuation mechanism and controllable to drive the actuation mechanism to extend and retract the cable, wherein,
the control system is operable to stop the automated or remote control mode of operation, comprising causing the cable actuator apparatus to extend the cable.

2. The system of claim 1, wherein the stopping the automated or remote control mode of operation is performed for: switching to a manual control mode of operation; or a shutdown process.

3. The system of claim 1, wherein actuation mechanism comprises a linear actuator.

4. The system of claim 3, wherein the linear actuator comprises a screw mechanism, the screw mechanism converting rotational motion of the motor to linear motion of the cable.

5. The system of claim 1, wherein the actuation mechanism comprises a pulley.

6. The system of claim 1, wherein the control system comprises a safety module that monitors operation of the one or more actuator apparatuses.

7. The system of claim 6, wherein each of the one or more actuator apparatuses comprises a respective sensor that generates sensor output indicative of a configuration of the actuator apparatus, and the safety module receives the sensor output.

8. The system of claim 1, wherein the cable is movable between fully extended and fully retracted configurations, and controlling the cable actuator apparatus to extend the cable when stopping the automated or remote control mode of operation comprises moving the cable to the fully extended configuration.

9. The system of claim 1, the control system monitors operation of the machine and initiates a shutdown process responsive to detecting a shutdown condition.

10. The system of claim 9, wherein the shutdown process comprises causing the cable actuator apparatus to extend the cable of the cable actuator apparatus.

11. The system of claim 9, wherein the machine comprises a golf turf maintenance machine.

12. A system for enabling automated or remote control of a machine, the system comprising:
one or more actuator apparatuses connectable to one or more machine control components of the machine;
a control system operatively connected to the one or more actuator apparatuses, the control system generating control signalling to operate the one or more actuator apparatuses during the automated or remote control mode of operation, wherein the one or more actuator apparatuses comprise a rotary actuator apparatus and the one or more machine control components comprises a rotary control component, the rotary actuator apparatus connectable to the rotary control component, the rotary actuator apparatus comprising:
a motor controllable by the control system;
a first wheel driven by the motor;
a first rotary encoder comprising a first encoder disc coupled to the first wheel and a first sensor configured to generate first sensor output modulated by a pattern encoded on the first encoder disc;
a second wheel coupled to the first wheel for transmission of rotational motion therebetween, the second wheel being rotationally fixed with steering wheel such that rotation of the second wheel rotates the steering wheel;
a second rotary encoder comprising a second encoder disc coupled to the second wheel and a second sensor configured to generate second sensor output modulated by a pattern encoded on the second encoder disc, wherein
the first wheel has a different size than the second wheel, such that the combination of first and second sensor outputs is readable to provide an angular position of the first wheel over a rotational range exceeding one revolution of the second wheel.

13. The system of claim 12, wherein one full rotation of the second wheel corresponds to a non-integer number of rotations of the first wheel.

14. The system of claim 12, wherein the first wheel comprises a first pulley wheel and the second wheel comprises a second pulley wheel, and the rotary actuator apparatus further comprises a belt coupling the first and second pulley wheels.

15. The system of claim 12, wherein the first wheel comprises a first gear and the second wheel comprises a second gear engaged with the first gear.

16. The system of claim 12, wherein the first encoder disc defines a first modulated outer rim and the first sensor comprises a first optical sensor positioned such that the first modulated outer rim modulates light incident on the first optical sensor as the first wheel rotates.

17. The system of claim 16, wherein the second encoder disc defines a second modulated outer rim and the second sensor comprises a second optical sensor positioned such that the second modulated outer rim modulates light incident on the second optical sensor as the second wheel rotates.

18. A controller for a machine having an automated or remote mode of operation and a manual mode of operation, the machine comprising a cable actuator apparatus operable connected to a machine control component, the cable actuator apparatus being operable to extend and retract a cable to thereby actuate the machine control component, the controller comprising:
one or more processors; and
memory having stored thereon processor-executable instructions that, when executed, cause the one or more processors to implement a method comprising:
detecting a trigger to stop the automated or remote control mode of operation; and
responsive to detecting the trigger, controlling the cable actuator apparatus to extend the cable.

19. The controller of claim 18, wherein the controller is configured to monitor operation of the machine and initiate a shutdown process responsive to detecting a shutdown condition, wherein detecting the trigger comprises detecting the shutdown condition.

20. The controller of claim 18, wherein detecting the trigger comprises receiving input including a command to stop the automated or remote control mode of operation.
